(19) United States
(12) Patent Application Publication
(10) Pub. No.: US 2024/0316849 A1
(43) Pub. Date: Sep. 26, 2024

(54) Molding Management System

(71) Applicant: SEIKO EPSON CORPORATION, Tokyo (JP)

(72) Inventors: Kosuke ATSUTA, Shiojiri (JP); Soji SHIOZAWA, Matsumoto (JP)

(21) Appl. No.: 18/613,782

(22) Filed: Mar. 22, 2024

(30) Foreign Application Priority Data
Mar. 24, 2023 (JP) 2023-048295

(51) Int. Cl. B29C 45/76

(52) U.S. Cl. CPC B29C 45/76; B29C 2945/76939

(57) ABSTRACT

A molding management system includes: a production process storage unit configured to store a plurality of pieces of production process information that are identification information of production processes of a molded article; a defect classification storage unit configured to store master data including a plurality of pieces of defect classification information that are information related to classification of a defect of the molded article; a first receiving unit configured to receive selection of the production process information stored in the production process storage unit; a second receiving unit configured to receive selection of the defect classification information provided in the master data; a process defect storage unit configured to store the production process information received by the first receiving unit and the defect classification information received by the second receiving unit in association with each other; and a third receiving unit configured to receive, when the defect occurs in the molded article in any one production process of the production processes, of selection the defect classification information stored in the process defect storage unit in association with the production process information of the production process in which the defect occurs.

The present application is based on, and claims priority from JP Application Serial Number 2023-048295, filed Mar. 24, 2023, the disclosure of which is hereby incorporated by reference herein in its entirety.

### BACKGROUND

### 1. Technical Field

The present disclosure relates to a molding management system.

### 2. Related Art

In a program and an information processing device disclosed in JP-A-2019-119172, tag data in which a shot number is associated with a non-defective tag indicating that a molded article is a non-defective article or a defective tag indicating that a molded article is a defective article is stored in a storage device in association with temperature data, pressure data, and flow velocity data in a metal mold. The tag data described above is data input by a user using an input interface such as a keyboard.

JP-A-2019-119172 is an example of the related art.

### SUMMARY

In a case where a defect occurs in production of a molded article, a user may store a production process in which the defect occurs and detailed information about the occurred defect in association with each other in a molding management system. In this case, when the user inputs detailed information about a defect using a keyboard or the like, there is a problem that it takes time to input the information.

According to a first aspect of the present disclosure, a molding management system is provided. The molding management system includes: a production process storage unit configured to store a plurality of pieces of production process information that are identification information of production processes of a molded article; a defect classification storage unit configured to store master data including a plurality of pieces of defect classification information that are information related to classification of a defect of the molded article; a first receiving unit configured to receive selection of the production process information stored in the production process storage unit; a second receiving unit configured to receive selection of the defect classification information provided in the master data; a process defect storage unit configured to store the production process information received by the first receiving unit and the defect classification information received by the second receiving unit in association with each other; and a third receiving unit configured to receive, when the defect occurs in the molded article in any one production process of the production processes, selection of the defect classification information stored in the process defect storage unit in association with the production process information of the production process in which the defect occurs.

### BRIEF DESCRIPTION OF THE DRAWINGS

FIG. 1 is a diagram illustrating a schematic configuration of a molding management system.

FIG. 2 is a flowchart illustrating defect classification association processing performed by the molding management system.

FIG. 3 is a view illustrating a production process list screen.

FIG. 4 is a view illustrating a defect classification association screen.

FIG. 5 is a flowchart illustrating defect input processing performed by the molding management system.

FIG. 6 is a view illustrating a defect input screen.

### DESCRIPTION OF EMBODIMENTS

### A: First Embodiment

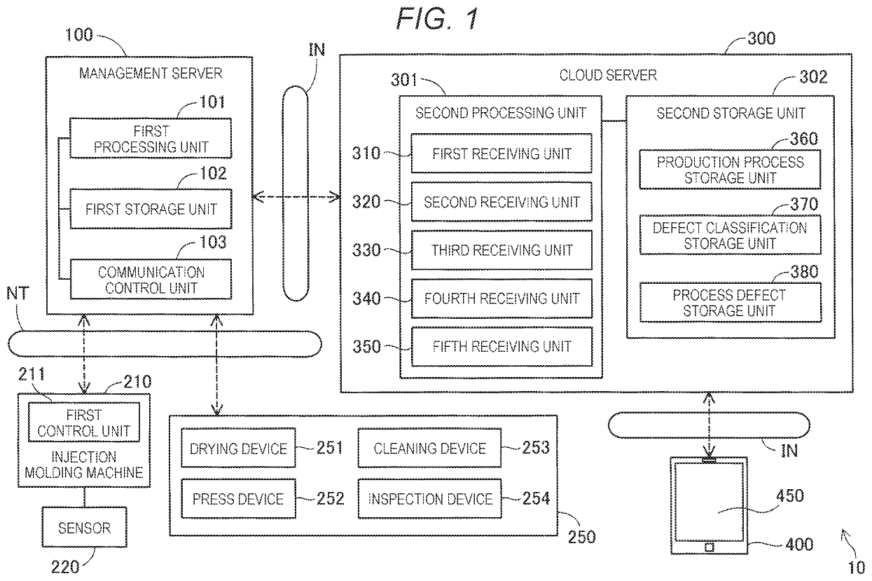

FIG. 1 is a diagram illustrating a schematic configuration of a molding management system 10. The molding management system 10 includes a management server 100, an injection molding machine 210, a sensor 220, a drying device 251, a press device 252, a cleaning device 253, an inspection device 254, a cloud server 300, and a terminal device 400. The drying device 251, the press device 252, the cleaning device 253, and the inspection device 254 are collectively referred to as peripheral machines 250. The management server 100 is configured to communicate with the injection molding machine 210 and the peripheral machines 250 via a network NT. The network NT may be, for example, a LAN, a WAN, or an Internet. The sensor 220 is coupled to the injection molding machine 210. The cloud server 300 is configured to communicate with the management server 100 and the terminal device 400 via an Internet IN. Although FIG. 1 illustrates an example in which the number of each of the injection molding machine 210, the sensor 220, and the peripheral machines 250 provided in the molding management system 10 is one, the molding management system 10 may include a plurality of injection molding machines 210, a plurality of sensors 220, and a plurality of peripheral machines 250.

The injection molding machine 210 is a device that performs injection molding. The injection molding machine 210 includes a first control unit 211, an injection device (not illustrated), and a mold clamping device (not illustrated). A mold having a cavity is attached to the mold clamping device. The mold may be made of a metal, ceramic, or a resin. A mold made of a metal is referred to as a metal mold. The first control unit 211 is implemented by a computer including one or more processors, a storage device, and an input and output interface that inputs a signal from and outputs a signal to the outside. The first control unit 211 may be implemented by a plurality of computers.

The first control unit 211 performs injection molding by controlling units of the injection molding machine 210 based on molding conditions acquired from the cloud server 300 via the management server 100, and molds a molded article. More specifically, the first control unit 211 controls the mold clamping device to clamp the mold, and controls the injection device to inject a shaping material obtained by plasticizing a material into the mold, thereby molding a molded article having a shape corresponding to a shape of the cavity formed in the mold.

The sensor 220 measures injection pressure, a temperature of the metal mold, an injection filling time, and the like that are physical quantities related to an operation state of the injection molding machine 210. The sensor 220 is, for example, a pressure sensor that measures injection pressure or a temperature sensor that measures a temperature of the metal mold. The sensor 220 transmits a measured physical quantity related to an operation state of the injection molding machine 210 to the management server 100 via the first control unit 211 of the injection molding machine 210. The sensor 220 may be configured to communicate with the management server 100 via a network NT. In this case, the sensor 220 may transmit a measured physical quantity related to an operation state of the injection molding machine 210 to the management server 100 without passing through the first control unit 211.

The drying device 251 is a device that dries a material used in the injection molding machine 210. The press device 252 is a device that produces, by press processing, an insert article to be attached to a mold by insert molding. The cleaning device 253 is a device that cleans a molded article molded by the injection molding machine 210. The inspection device 254 is a device that inspects a molded article molded by the injection molding machine 210.

The management server 100 is implemented by a computer including a first processing unit 101, a first storage unit 102, and a communication control unit 103. The first processing unit 101 includes one or more processors and a main storage device. The first storage unit 102 is implemented by an auxiliary storage device such as a hard disk drive. The communication control unit 103 includes a communication circuit for controlling communication with other devices such as the cloud server 300, the injection molding machine 210, and the peripheral machines 250. The management server 100 may be implemented by a plurality of computers. The management server 100 may include a display device such as a liquid crystal display and an input device such as a keyboard and a mouse.

The first processing acquires a physical quantity related to an operation state of the injection molding machine 210 transmitted from the sensor 220. The physical quantity related to an operation state of the injection molding machine 210 acquired by the first processing unit 101 is stored in the first storage unit 102. The first processing unit 101 may transmit the physical quantity related to an operation state of the injection molding machine 210 to the cloud server 300. In this case, the physical quantity related to an operation state of the injection molding machine 210 is stored in a second storage unit 302 of the cloud server 300.

The terminal device 400 is implemented as a computer including a CPU, a storage device, and a display unit 450. Examples of the terminal device 400 include a tablet terminal, a notebook computer, a smartphone, or a handy terminal. The display unit 450 displays various screens output from the cloud server 300. The display unit 450 may have a touch panel function. The terminal device 400 is also referred to as an information terminal.

The cloud server 300 is a server used via the Internet IN. The cloud server 300 includes a second processing unit 301 and the second storage unit 302. The first storage unit 102 of the management server 100 and the second storage unit 302 of the cloud server 300 are also collectively referred to as a storage unit. The management server 100 and the cloud server 300 may be integrated as one server.

The second storage unit 302 includes a production process storage unit 360, a defect classification storage unit 370, and a process defect storage unit 380.

The production process storage unit 360 stores a plurality of pieces of production process information that are identification information of production processes of a molded article. The production processes of a molded article include a drying process, a press process, a molding process, an insert molding process, a multicolor molding process, a conveying process, an appearance inspection process, a deburring process, a cleaning process, a shipping inspection process, a shipping approval process, a packaging process, and a finished inventory process. The production process information is identification information assigned to each production process. The production process information is a name of a production process, an ID number assigned to each production process, or the like.

Hereinafter, the production processes described above will be described in detail. The drying process is a process in which a material used for molding a molded article is dried by the drying device 251. The press process is a process in which an insert article used in the insert molding process is produced by the press device 252. The molding process is a process in which a molded article is molded by the injection molding machine 210. The insert molding process is a process in which the injection molding machine 210 molds a molded article in which the insert article and a resin are integrated. The insert molding process is performed by the injection molding machine 210 that can perform insert molding. The multicolor molding process is a process in which the injection molding machine 210 molds a molded article in which resins of different colors and materials are integrated. The multicolor molding process is performed by the injection molding machine 210 that can perform multicolor molding. Insert molding or multicolor molding is not performed in the molding process. The conveying process is a process of conveying a material or a molded article between the injection molding machine 210 and the peripheral machines 250. The appearance inspection process is a process in which a molded article is inspected by the inspection device 254 immediately after the molded article is molded by the injection molding machine 210. The deburring process is a process of removing a burr from the molded article. The cleaning process is a process in which the molded article is cleaned by the cleaning device 253. The shipping inspection process is a process in which the molded article is inspected by the inspection device 254 before the molded article is shipped. The shipping approval process is a process in which there is no problem in quality of the molded article and shipping is approved by a factory manager. The packaging process is a process of packaging the molded article. An operation of putting the molded article into a storage container without packaging the molded article or an operation of putting the molded article on a storage tray without packaging the molded article is also included in the packaging process. The finished inventory process is a production process performed after the packaging process. In the finished inventory process, the molded article is stored in an inventory or the like in a state where the molded article can be shipped.

The defect classification storage unit 370 stores master data including a plurality of pieces of defect classification information that are information related to classification of defects of a molded article. The master data includes defect classification information of defects occurring in all production processes. The defect classification information includes insufficient filling, chipping and cracking, damage, falling, a burr, a dimensional defect, stain, bending, discoloration, burning, an inspection error, an insert article defect, an insert article insertion error, insufficient filling (a first color), insufficient filling (a second color), deterioration, and the like. Here, insufficient filling refers to that a cavity is not sufficiently filled with a shaping material when the shaping material is injected into the mold. The insert article defect refers to that a defect occurs in a molded article due to a defect in an insert article in the insert molding process. The insert article insertion error refers to that there is a problem in attaching an insert article to a mold in the insert molding process. The insufficient filling (a first color) refers to that a cavity is not sufficiently filled with a shaping material of the first color in the multicolor molding process. The insufficient filling (a second color) refers to that a cavity is not sufficiently filled with a shaping material of the second color which is a color different from the first color in the multicolor molding process.

The process defect storage unit 380 stores the production process information and the defect classification information in association with each other.

The second processing unit 301 of the cloud server 300 includes a first receiving unit 310, a second receiving unit 320, a third receiving unit 330, a fourth receiving unit 340, and a fifth receiving unit 350. The first receiving unit 310, the second receiving unit 320, the third receiving unit 330, the fourth receiving unit 340, and the fifth receiving unit 350 are implemented by the second processing unit 301 executing a program stored in the second storage unit 302. These receiving units may be implemented by circuits.

The first receiving unit 310 receives selection of the production process information stored in the production process storage unit 360.

The second receiving unit 320 receives selection of the defect classification information provided in the master data stored in the defect classification storage unit 370.

The third receiving unit 330 receives selection of the defect classification information when a defect occurs in a molded article in any one of the production processes.

The fourth receiving unit 340 receives selection of information related to an outsourcing company where a production process is performed when producing a molded article.

The fifth receiving unit 350 receives selection of finished inventory process information that is information for determining whether the finished inventory process is a production process performed after the packaging process.

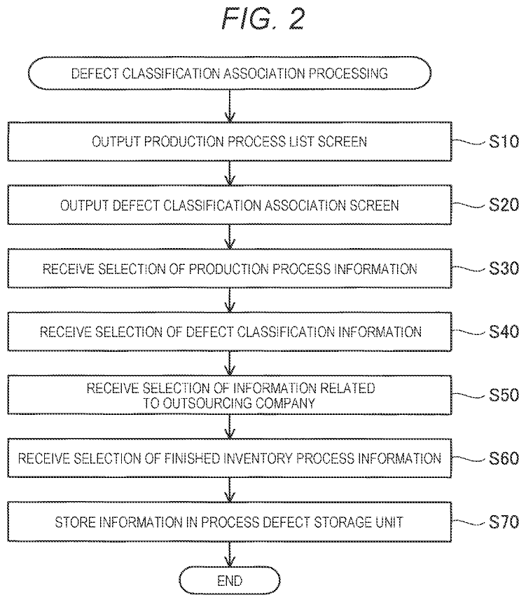

FIG. 2 is a flowchart illustrating defect classification association processing performed by the molding management system 10. The defect classification association processing is performed when a predetermined operation is performed on the molding management system 10.

In step S10, the second processing unit 301 of the cloud server 300 generates data of a production process list screen SC1 on which production process information stored in the production process storage unit 360 is displayed, and outputs the data to the terminal device 400. The production process list screen SC1 is displayed on the display unit 450 of the terminal device 400.

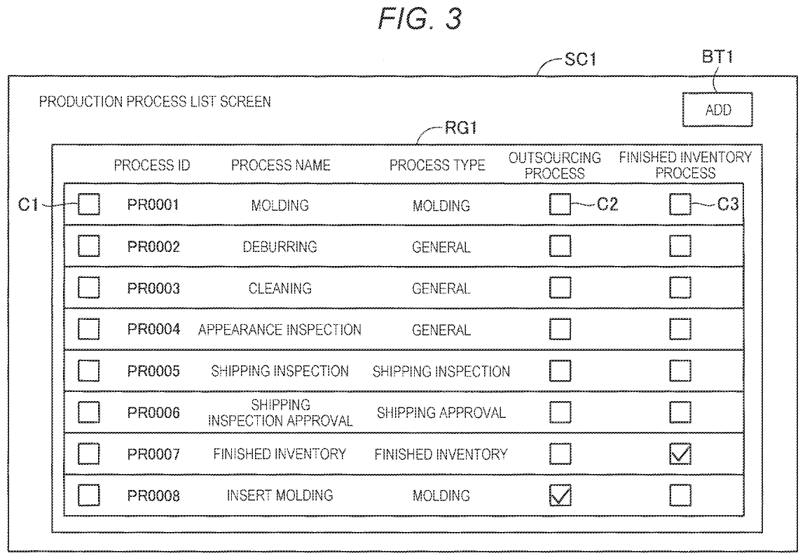

FIG. 3 is a view illustrating the production process list screen SC1. The production process list screen SC1 includes a production process display region RG1 and an add button BT1.

A process ID serving as production process information, a process name serving as production process information, and a process type are displayed in the production process display region RG1 for each production process. A check box C2 indicating whether a production process is the outsourcing process and a check box C3 indicating whether a production process is the finished inventory process are displayed in the production process display region RG1 for each production process. In addition, a check box C1 associated with each production process is provided in the production process display region RG1.

The process type is information related to a type of a production process. There are five process types including molding, general, shipping inspection, shipping approval, and finished inventory. A production process is classified into any one of the process types. A production process whose process type is molding is a process of molding a molded article such as the molding process, the insert molding process, and the multicolor molding process. A production process whose process type is general is a process excluding the process of molding a molded article among processes of manufacturing a molded article, such as the deburring process, the cleaning process, and the appearance inspection process. A production process whose process type is shipping inspection is the shipping inspection process. A production process whose process type is shipping approval is the shipping approval process. A production process whose process type is finished inventory is the finished inventory process. The production process information and the process type are stored in the production process storage unit 360 in association with each other in advance. The number of process types may not be five as described above. The production process display region RG1 may not display the process type.

The outsourcing process is a production process performed in a factory other than a factory including the injection molding machine 210 or the peripheral machines 250 provided in the molding management system 10. Hereinafter, the factory having the injection molding machine 210 or the peripheral machines 250 provided in the molding management system 10 is also referred to as a factory of an own company, and a factory other than the factory of the own company is also referred to as a factory of another company. That is, the outsourcing process is a production process performed in a factory of another company. For example, when an insert molding process is performed by an injection molding machine provided in a factory of another company, the insert molding process is an outsourcing process. When a production process is an outsourcing process, the check box C2 is checked. When a production process is the finished inventory process, the check box C3 is checked.

In step S20 illustrated in FIG. 2, the second processing unit 301 of the cloud server 300 generates data of a defect classification association screen SC2 that is a screen for enabling a user to select defect classification information associated with a production process, and outputs the data to the terminal device 400. The defect classification association screen SC2 is displayed on the display unit 450 of the terminal device 400. The step S20 is performed when the add button BT1 is clicked on the production process list screen SC1 illustrated in FIG. 3.

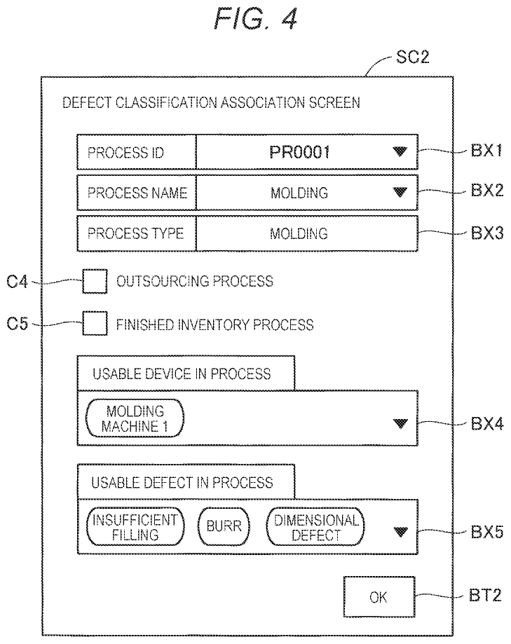

FIG. 4 is a view illustrating the defect classification association screen SC2. The defect classification association screen SC2 includes a selection field BX1, a selection field BX2, a display field BX3, a check box C4, a check box C5, a selection field BX4, a selection field BX5, and an OK button BT2. A process ID is selected in the selection field BX1. The selection field BX1 is configured to display a list of process IDs stored in the production process storage unit 360 when a user clicks the selection field BX1. A process name is selected in the selection field BX2. The selection field BX2 is configured to display a list of process names stored in the production process storage unit 360 when a user clicks the selection field BX2. A process type is displayed in the display field BX3. Information indicating whether a production process is an outsourcing process is selected in the check box C4. Information indicating whether a production process is a finished inventory process is selected in the check box C5. The injection molding machine 210 or the peripheral machines 250 provided in the molding management system 10 is selected in the selection field BX4. The selection field BX4 is configured to display a list of the injection molding machine 210 and the peripheral machines 250 provided in the molding management system 10 when a user clicks the selection field BX4. Defect classification information is selected in the selection field BX5. The selection field BX5 is configured to display a list of defect classification information provided in the master data stored in the defect classification storage unit 370 when a user clicks the selection field BX5.

A user inputs information to the defect classification association screen SC2. Hereinafter, information input to the defect classification association screen SC2 by a user will be described.

A user selects a process ID of a production process associated with defect classification information in the selection field BX1, or a process name of a production process associated with defect classification information in the selection field BX2. A process type stored in the production process storage unit 360 in association with the process ID selected in the selection field BX1 or the process name selected in the selection field BX2 is displayed in the display field BX3.

When a production process selected in the selection field BX1 or the selection field BX2 is an outsourcing process, the user checks the check box C4. When the production process selected in the selection field BX1 or the selection field BX2 is performed in a factory of another company, the user checks the check box C4. For example, when the molding management system 10 does not include the injection molding machine 210 that can perform insert molding or the injection molding machine 210 that can perform multicolor molding, the user sets the insert molding process and the multicolor molding process as outsourcing processes. In this case, the user selects the insert molding process or the multicolor molding process in the selection field BX1 or the selection field BX2, and checks the check box C4.

When the production process selected in the selection field BX1 or the selection field BX2 is the finished inventory process, the user checks the check box C5.

In the selection field BX4, the user selects the injection molding machine 210 or the peripheral machines 250 used in the production process selected in the selection field BX1 or the selection field BX2. A name of the injection molding machine 210 or the peripheral machines 250 selected by the user is displayed in the selection field BX4.

In the selection field BX5, the user selects defect classification information associated with the production process selected in the selection field BX1 or the selection field BX2. The defect classification information selected by the user displayed in the selection field BX5.

In the selection field BX5, the user selects defect classification information indicating that a defect may occur in the production process selected in the selection field BX1 or the selection field BX2. Hereinafter, an example of the defect classification information selected by the user in the selection field BX5 for each production process will be described. When the production process is the drying process, the user selects defect classification information such as discoloration and burning. When the production process is the press process, the user selects defect classification information such as a burr, a dimensional defect, and bending. When the production process is the molding process, the user selects defect classification information such as insufficient filling, a burr, and a dimensional defect. When the production process is the insert molding process, the user selects defect classification information such as an insert article defect, an insert article insertion error, and insufficient filling. When the production process is the multicolor molding process, the user selects defect classification information such as insufficient filling (a first color), insufficient filling (a second color), and a burr. When the production process is the conveying process, the user selects defect classification information such as chipping and cracking, damage, and falling. When the production process is the appearance inspection process, the user selects defect classification information such as insufficient filling, damage, and a dimensional defect. When the production process is the deburring process, the user selects defect classification information such as chipping and cracking, and damage. When the production process is the cleaning process, the user selects defect classification information such as stain, chipping and cracking, and damage. When the production process is the shipping inspection process, the user selects defect classification information such as insufficient filling, damage, and a dimensional defect. When the production process is the shipping approval process, the user selects defect classification information such as falling and an inspection error. When the production process is the packaging process, the user selects defect classification information such as falling, chipping and cracking, and damage. When the production process is the finished inventory process, the user selects defect classification information such as stain and deterioration.

In step S30 illustrated in FIG. 2, the first receiving unit 310 receives the process ID selected in the selection field BX1 on the defect classification association screen SC2 illustrated in FIG. 4 or the process name selected in the selection field BX2 as production process information. The step S30 and subsequent steps are performed when the OK button BT2 on the defect classification association screen SC2 is clicked.

In step S40 illustrated in FIG. 2, the second receiving unit 320 receives the defect classification information selected in the selection field BX5 on the defect classification association screen SC2 illustrated in FIG. 4.

In step S50 illustrated in FIG. 2, the fourth receiving unit 340 receives selection of information related to an outsourcing company. The information related to an outsourcing company indicates whether a production process is an outsourcing process. When the check box C4 on the defect classification association screen SC2 illustrated in FIG. 4 is checked, the fourth receiving unit 340 receives information indicating that a production process is an outsourcing process as the information related to an outsourcing company. When the check box C4 on the defect classification association screen SC2 illustrated in FIG. 4 is not checked, the fourth receiving unit 340 receives information indicating that a production process is not an outsourcing process as the information related to an outsourcing company. When a production process is an outsourcing process, the production process is performed in a factory of another company. When the production process is not an outsourcing process, the production process is performed in a factory of an own company.

In step S60 illustrated in FIG. 2, the fifth receiving unit 350 receives selection of finished inventory process information. The finished inventory process information is information for determining whether a production process is a process performed after the packaging process. When the check box C5 on the defect classification association screen SC2 illustrated in FIG. 4 is checked, the fifth receiving unit 350 receives information indicating that a production process is a process performed after the packaging process as the finished inventory process information. When the check box C5 on the defect classification association screen SC2 illustrated in FIG. 4 is not checked, the fifth receiving unit 350 receives information indicating that a production process is not a process performed after the packaging process as the finished inventory process information.

In step S70 illustrated in FIG. 2, the second processing unit 301 of the cloud server 300 stores the production process information received by the first receiving unit 310 in step S30, the defect classification information received by the second receiving unit 320 in step S40, the information related to an outsourcing company received by the fourth receiving unit 340 in step S50, and the finished inventory process information received by the fifth receiving unit 350 in step S60 in the process defect storage unit 380 in association with one another. The defect classification association processing is performed as described above.

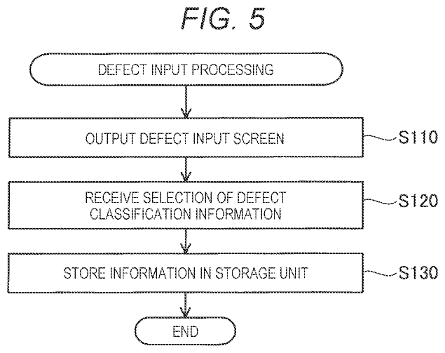

FIG. 5 is a flowchart illustrating defect input processing performed by the molding management system 10. The defect input processing is performed when a predetermined operation is performed on the molding management system 10 in a case where a defect occurs in a molded article in any one of the production processes.

In step S110, the second processing unit 301 of the cloud server 300 generates data of a defect input screen SC3 that is a screen for enabling a user to select defect classification information, and outputs the data to the terminal device 400. The defect input screen SC3 is displayed on the display unit 450 of the terminal device 400.

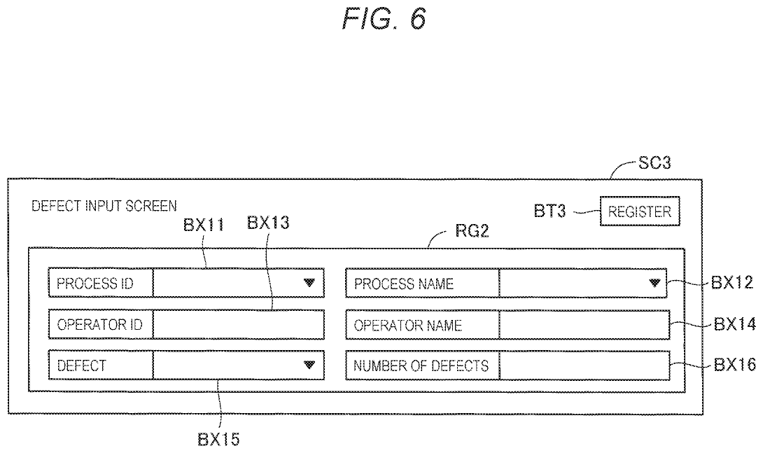

FIG. 6 is a view illustrating the defect input screen SC3. The defect input screen SC3 includes a defect input region RG2 and a registration button BT3. The defect input region RG2 includes a selection field BX11, a selection field BX12, an input field BX13, an input field BX14, a selection field BX15, and an input field BX16. A process ID is selected in the selection field BX11. The selection field BX11 is configured to display a list of process IDs that are production process information stored in the production process storage unit 360 when a user clicks the selection field BX11. A process name is selected in the selection field BX12. The selection field BX12 is configured to display a list of process names that are production process information stored in the production process storage unit 360 when a user clicks the selection field BX12. An ID number of a user is input to the input field BX13. A name of the user is input to the input field BX14. Defect classification information is selected in the selection field BX15. The selection field BX15 is configured to display a list of defect classification information stored in the process defect storage unit 380 in association with the production process information selected in the selection field BX11 or the selection field BX12 when a user clicks the selection field BX15. The number of molded articles in which a defect occurs is input to the input field BX16.

A user inputs information to the defect input screen SC3. The user selects a process ID of a production process in which a defect occurs in the selection field BX11 or a process name of a production process in which a defect occurs in the selection field BX12. The user inputs an ID number of an operator who performs a production process in which a defect occurs in the input field BX13. The user inputs a name of the operator who performs a production process in which a defect occurs in the input field BX14. In the selection field BX15, the user selects defect classification information corresponding to a defect occurring in the production process selected in the selection field BX11 or the selection field BX12. The user inputs the number of molded articles in which a defect occurs in the input field BX16. For example, when there are five molded articles with insufficient filling in the molding process, the user selects production process information corresponding to the molding process in the selection field BX11 or the selection field BX12, selects defect classification information of “insufficient filling” in the selection field BX15, and inputs “5” in the input field BX16.

In step S120 illustrated in FIG. 5, the third receiving unit 330 receives the defect classification information selected in the selection field BX15 on the defect input screen SC3 illustrated in FIG. 6. That is, when a defect occurs in a molded article in any one of the production processes, the third receiving unit 330 receives selection of defect classification information stored in the process defect storage unit 380 in association with production process information of the production process in which the defect occurs. In step S120, the second processing unit 301 receives the production process information selected in the selection field BX11 and the selection field BX12 and information input in the input field BX13, the input field BX14, and the input field BX16. The step S120 is performed when the registration button BT3 on the defect input screen SC3 is clicked.

In step S130 illustrated in FIG. 5, the second processing unit 301 stores the defect classification information received by the third receiving unit 330 in step S120, the production process information selected in the selection field BX11 and the selection field BX12, and the information input to the input field BX13, the input field BX14, and the input field BX16 in the second storage unit 302 in association with one another. That is, the second processing unit 301 stores production process information of a production process in which a defect occurs in a molded article and defect classification information of the occurred defect in the second storage unit 302 in association with each other. The defect input processing is performed as described above.

According to the molding management system 10 in the embodiment described above, production process information selected from the production process information stored in the production process storage unit 360 and defect classification information selected from the defect classification information provided in the master data stored in the defect classification storage unit 370 are stored in the process defect storage unit 380 in association with each other. When a defect occurs in a molded article in any one of the production processes, the third receiving unit 330 receives selection of defect classification information stored in the process defect storage unit 380 in association with production process information of a production process in which a defect occurs. Therefore, when a defect occurs in a molded article in any one of the production processes, a user can select the defect classification information stored in the process defect storage unit 380 in association with production process information of the production process in which the defect occurs. Accordingly, it is not necessary to input detailed information of the occurred defect using a keyboard or the like, and thus it is possible to shorten a time taken to input the detailed information of the defect.

In the embodiment, the fourth receiving unit 340 receives selection of information related to an outsourcing company where a production process is performed. A user may order a production process that cannot be performed in a factory of an own company to a factory of another company. In the defect classification association processing, a user can store production process information of a production process that cannot be performed in a factory of an own company and defect classification information of a defect occurring in the production process that cannot be performed in the factory of the own company in the process defect storage unit 380 in association with each other. Therefore, when a defect occurs in a molded article in a production process performed in a factory of another company, the user can select defect classification information of a defect occurring in the production process performed in the factory of another company in the defect input processing.

In the embodiment, the fifth receiving unit 350 receives selection of finished inventory process information. In the finished inventory process, a defect occurs since a molded article is stored for a long period of time. For example, there is a defect in which stain adheres to a molded article due to electrostatic electricity, deterioration of a molded article due to storage for a long period, and the like. Therefore, a defect that may occur in the finished inventory process includes a defect of a type different from a defect occurring in a process other than the finished inventory process. In the defect classification association processing, a user can store only defect classification information of a defect that may occur in the finished inventory process in the process defect storage unit 380 in association with process identification information of the finished inventory process. Therefore, when a defect occurs in the finished inventory process, the user can easily select, in the defect input processing, defect classification information corresponding to the defect occurring in the finished inventory process.

In the embodiment, the defect classification storage unit 370 stores the master data including a plurality of pieces of defect classification information. The master data includes defect classification information of all production processes. Therefore, a user can edit the defect classification information of all the production processes by editing one piece of master data. Accordingly, the master data of defect classification information can be easily managed as compared with a case where the master data including defect classification information of a defect occurring in each production process is stored for each production process in the defect classification storage unit 370.

### B. Other Embodiments

(B-1) In the embodiment described above, the molding management system 10 includes the fourth receiving unit 340. On the other hand, the molding management system 10 may not include the fourth receiving unit 340. In this case, the defect classification association screen SC2 may not include the check box C4. In addition, the process defect storage unit 380 may not store information related to an outsourcing company.

(B-2) In the embodiment described above, the molding management system 10 includes the fifth receiving unit 350. On the other hand, the molding management system 10 may not include the fifth receiving unit 350. In this case, the defect classification association screen SC2 may not include the check box C5. In addition, the process defect storage unit 380 may not store finished inventory process information.

(B-3) In the embodiment described above, the second processing unit 301 of the cloud server 300 includes the first receiving unit 310, the second receiving unit 320, the third receiving unit 330, the fourth receiving unit 340, and the fifth receiving unit 350. On the other hand, the first processing unit 101 of the management server 100 may include some or all of the first receiving unit 310, the second receiving unit 320, the third receiving unit 330, the fourth receiving unit 340, and the fifth receiving unit 350.

(B-4) In the embodiment described above, the second storage unit 302 of the cloud server 300 includes the production process storage unit 360, the defect classification storage unit 370, and the process defect storage unit 380. On the other hand, the first storage unit 102 of the management server 100 may include the production process storage unit 360, the defect classification storage unit 370, and the process defect storage unit 380.

(B-5) In the embodiment described above, the molding management system 10 includes the drying device 251, the press device 252, the cleaning device 253, and the inspection device 254. On the other hand, the molding management system 10 may not include some or all of the drying device 251, the press device 252, the cleaning device 253, and the inspection device 254.

### C. Other Aspects

The present disclosure is not limited to the embodiments described above, and can be implemented in various aspects without departing from the spirit of the present disclosure. For example, the present disclosure can be implemented in the following aspects. In order to solve a part of or all of problems of the present disclosure, or to achieve a part of or all of effects of the present disclosure, technical features of the embodiments described above corresponding to technical features in the following aspects can be replaced or combined as appropriate. The technical features can be deleted as appropriate unless described as being essential in the specification.

(1) According to an aspect of the present disclosure, a molding management system is provided. The molding management system includes: a production process storage unit configured to store a plurality of pieces of production process information that are identification information of production processes of a molded article; a defect classification storage unit configured to store master data including a plurality of pieces of defect classification information that are information related to classification of a defect of the molded article; a first receiving unit configured to receive selection of the production process information stored in the production process storage unit; a second receiving unit configured to receive selection of the defect classification information provided in the master data; a process defect storage unit configured to store the production process information received by the first receiving unit and the defect classification information received by the second receiving unit in association with each other; and a third receiving unit configured to receive, when the defect occurs in the molded article in any one production process of the production processes, selection of the defect classification information stored in the process defect storage unit in association with the production process information of the production process in which the defect occurs.

According to this aspect, in a case where a defect occurs in a molded article in any one of the production processes, a user does not need to input detailed information of the occurred defect using a keyboard or the like, and thus it is possible to shorten a time taken to input the detailed information of the defect.

(2) In the above aspect, the production processes may include a molding process and any one of a drying process, a press process, a conveying process, and a cleaning process.

According to this aspect, in a case where a defect occurs in a molded article in the production processes, it is not necessary to input detailed information of the occurred defect using a keyboard or the like, and thus it is possible to shorten a time taken to input the detailed information of the defect.

(3) In the above aspect, the molding management system may further include a fourth receiving unit configured to receive selection of information related to an outsourcing company where the production process is performed when producing the molded article, and the process defect storage unit may store the production process information received by the first receiving unit and the information related to the outsourcing company received by the fourth receiving unit in association with each other.

According to this aspect, when the defect occurs in the molded article in the production process performed at the outsourcing company, a user can select defect classification information stored in the process defect storage unit in association with the production process performed at the outsourcing company.

(4) In the above aspect, the production processes may include a molding process and a packaging process, the molding management system may further include a fifth receiving unit configured to receive selection of finished inventory process information that is information for determining whether the production process is a process performed after the packaging process, and the process defect storage unit may store the production process information received by the first receiving unit and the finished inventory process information received by the fifth receiving unit in association with each other.

According to this aspect, when a defect occurs in the molded article in a finished inventory process, a user can select defect classification information stored in the process defect storage unit in association with the finished inventory process.

What is claimed is:

1. A molding management system comprising:
a production process storage unit configured to store a plurality of pieces of production process information that are identification information of production processes of a molded article;
a defect classification storage unit configured to store master data including a plurality of pieces of defect classification information that are information related to classification of a defect of the molded article;
a first receiving unit configured to receive selection of the production process information stored in the production process storage unit;
a second receiving unit configured to receive selection of the defect classification information provided in the master data;
a process defect storage unit configured to store the production process information received by the first receiving unit and the defect classification information received by the second receiving unit in association with each other; and
a third receiving unit configured to receive, when the defect occurs in the molded article in any one production process of the production processes, selection of the defect classification information stored in the process defect storage unit in association with the production process information of the production process in which the defect occurs.

2. The molding management system according to claim 1, wherein
the production processes include a molding process and any one of a drying process, a press process, a conveying process, and a cleaning process.

3. The molding management system according to claim 1, further comprising:
a fourth receiving unit configured to receive selection of information related to an outsourcing company where the production process is performed when producing the molded article, wherein
the process defect storage unit stores the production process information received by the first receiving unit and the information related to the outsourcing company received by the fourth receiving unit in association with each other.

4. The molding management system according to claim 1, wherein
the production processes includes a molding process and a packaging process,
the molding management system includes a fifth receiving unit configured to receive selection of finished inventory process information that is information for determining whether the production process is a process performed after the packaging process, and
the process defect storage unit stores the production process information received by the first receiving unit and the finished inventory process information received by the fifth receiving unit in association with each other.
